(19) United States
(12) Patent Application Publication
(10) Pub. No.: US 2026/0316697 A1
(43) Pub. Date: Oct. 15, 2026

(54) VEHICLE TRIM COMPONENTS WITH CONNECTION FEATURES AT MULTIPLE ANGLES

(71) Applicant: FCA US LLC, Auburn Hills, MI (US)

(72) Inventors: Brian K. Begg, Auburn Hills, MI (US); Ian R. Williams, Auburn Hills, MI (US)

(21) Appl. No.: 19/179,343

(22) Filed: Apr. 15, 2025

(51) Int. Cl. B60R 13/02; F16B 5/06

(52) U.S. Cl. CPC B60R 13/0206; F16B 5/0642

(57) ABSTRACT

An assembly includes two connected trim components with a first trim component having two connectors that extends from differently angled portions of an inner surface of the first trim component. The second trim component has two connection voids that are formed in differently angled portions of the second trim component, and each void is arranged to receive a separate one of the connectors, and the connections between the connectors and connection voids are not parallel to each other.

### FIELD

The present disclosure relates to vehicle interior or exterior trim components connected together with connection features at multiple angles.

### BACKGROUND

Some panels or trim components of vehicles include portions at different angles with bends or corners between the portions, and these panels or trim components are connected to other similarly shaped components. It is difficult to assemble and connect the component together, and maintain control of the portions of the components that are at different angles.

### SUMMARY

In at least some implementations, an assembly includes a first trim component and a second trim component that is connected to the first trim component. The first trim component has a first outer surface, a first inner surface, a first connector that extends from the first inner surface and has a first connection surface that is spaced from the first inner surface, and the first trim component has a second connector that is spaced from the first connector and that extends from the first inner surface and has a second connection surface that is spaced from the first inner surface. The first connection surface is not parallel to the second connection surface. The second trim component has a second outer surface, a second inner surface, a first connection void extending through both the second outer surface and the second inner surface with a first retention surface defined by part of the second inner surface, and a second connection void with a second retention surface defined by part of the second inner surface. The first connector is received in the first connection void with the first connection surface abutting the first retention surface, and the second connector is received in the second connection void with the second connection surface abutting the second retention surface.

In at least some implementations, the first trim component has a thickness defined between the first inner surface and the first outer surface, the first connector is received in the first connection void in an assembly direction, and the second connector is received in and movable relative to the second connection void in the assembly direction. The second connection void has a length in the assembly direction that is greater than the thickness, and the first connection void has a length in the assembly direction that is equal to the thickness.

In at least some implementations, the first connector has a first end that is spaced from the first connection surface and is the farthest point of the first connector from the first inner surface, and the length of the second connection void is at least equal to a distance between the first end and the first retention surface.

In at least some implementations, an included angle between the first retention surface and the second retention surface is between 30 degrees and 120 degrees.

In at least some implementations, the second connection void includes an inlet portion and an end portion and the end portion has a dimension perpendicular to both the thickness of the second trim component and to the assembly direction that is less than the corresponding dimension of the inlet portion.

In at least some implementations, the second retention surface is defined by a portion of the second inner surface that defines the end portion.

In at least some implementations, the second connector is spaced from the first inner surface by a distance equal to or greater than the thickness of the second trim component in the area of the second connection void.

In at least some implementations, the second connection surface overlaps the second retention surface in a direction parallel to the assembly direction.

In at least some implementations, the first connection surface is parallel to the first retention surface.

In at least some implementations, the first trim component includes a first connector mount on which the first connector is received, the first connector mount is cantilevered at a first end to the first inner surface and extends to a second end, and the first connector overlaps the second end of the first connector mount and at least part of the first connector is movable relative to the first connector mount to enable a snap-fit receipt of the first connector in the first connection void.

In at least some implementations, the first connection surface is defined by a second end of the first connector that is opposite to a first end of the first connector that is adjacent to the second end of the first connector mount, and a distance between the second end and the first inner surface is equal to or greater than a thickness of the second trim component at the first connection void, where the thickness of the second trim component is defined between the second outer surface and the second inner surface.

In at least some implementations, the second end of the first connector is flexible and has a dimension greater than a corresponding dimension of the first connection void, and to first connector is constructed so that the second end flexes so that the second end is received through the first connection void during assembly and the second end is resilient so that the second end unflexes and overlaps the first retention surface in an assembled position of the trim components.

In at least some implementations, the first trim component includes a second connector mount on which the second connector is received, the second connector mount is cantilevered at a first end to the first inner surface and extends to a second end, and the second connector overlaps the second end of the second connector mount, and at least part of the second connector is movable relative to the second connector mount to provide a biasing force between the second connector and the second retention surface.

In at least some implementations, the second connection surface is defined by a second end of the second connector that is opposite to a first end of the second connector, and a distance between the second end and the first inner surface is equal to or greater than a thickness of the second trim component at the second connection void, where the thickness of the second trim component is defined between the second outer surface and the second inner surface.

In at least some implementations, part of the inner surface of the first trim component overlaps part of the outer surface of the second trim component, and wherein the first connector and the second connector each include a biasing member that is flexible and resilient and that provides a biasing force against the respective first retention surface and second retention surface that tends to pull the first inner surface toward the second outer surface.

In at least some implementations, the first connector and second connector are C-shaped spring clips that are received on corresponding connectors mounts of the first trim component and that can flex or move relative to the connector mounts to apply the biasing force.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a front view showing portions of two interconnected trim components for a vehicle;

FIG. 2 is an exploded rear view of the trim components showing the trim components separate, prior to assembly;

FIG. 3 is a rear view of the trim components in an intermediate assembly position; and

FIG. 4 is a rear view of the trim components in an assembled position.

### DETAILED DESCRIPTION

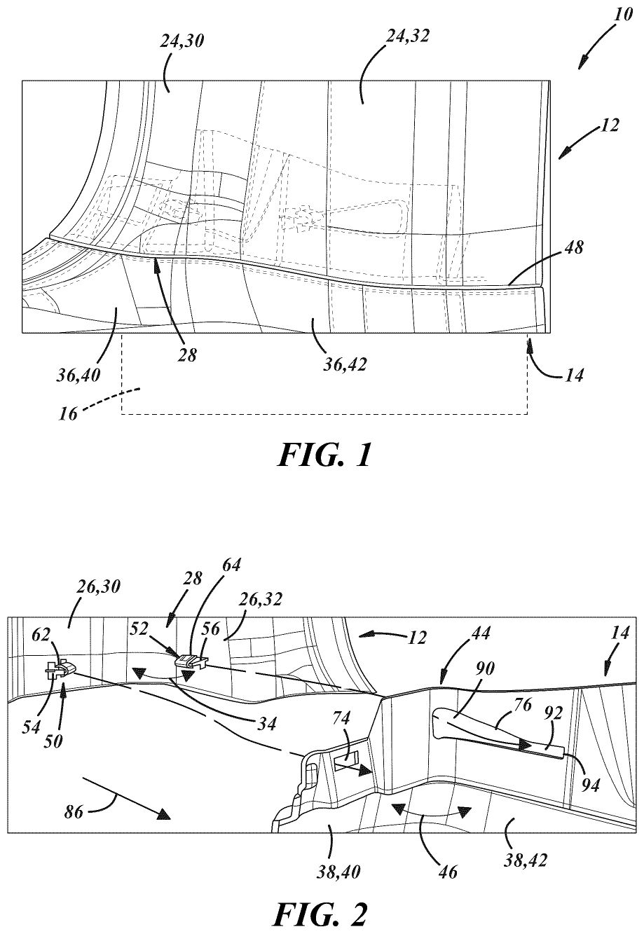

Referring in more detail to the drawings, FIG. 1 shows part of an assembly 10 of two trim components 12, 14 that define or wrap around a corner or other bend of the vehicle, or of a structural component of the vehicle. In the example shown, the trim components 12, 14 are provided about the interior of a vehicle pillar 16, and the trim components 12, 14 cover a first side of the pillar 16 and a second side of the pillar 16 that is oriented such that it is not parallel to the first side and a curve or bend defines a corner between the sides. While shown with interior trim components 12, 14, the disclosure herein is not limited to interior trim components. By way of non-limiting examples, some exterior trim components also cover sides of structures that are not parallel, such as may occur at the front and rear corners of the vehicle. There, exterior trim components, such as front or rear fascia/bumper panels, may cover part of a front side (or rear side) and part of a side of the vehicle, with a bend or corner between the sides.

As shown in FIGS. 1 and 4, a first trim component 12 is coupled to a second trim component 14, and part of the first trim component 12 overlaps part of the second trim component 14. The first trim component 12 includes an outer surface 24 at least part of which defines a show surface that is intended to be visible by persons in or near the vehicle, and the first trim component 12 includes an inner surface 26. The inner surface 26 is opposite to the outer surface 24 and generally is hidden from view in the assembled vehicle. The first trim component 12, as noted above, includes a bend or corner 28 that is defined between a first portion 30 and a second portion 32 that is arranged such that the outer and inner surfaces 24, 26 are not parallel to each other. In at least some implementations, an included angle 34 between at least part of the first portion 30 and at least part of the second portion 32 is at least thirty degrees, and may be between 30 and 120 degrees. In at least some implementations, and as in the example shown in the drawings, the included angle 34 between the first portion 30 and the second portion 32 is between eighty and one-hundred degrees. The corner 28 between the first and second portions 30, 32 is rounded to provide a smooth, radiused bend, but could be a sharp corner or of a different shape, as desired.

The second trim component 14 also includes an outer surface 36 at least part of which defines a show surface, an opposite inner surface 38, a first portion 40 and a second portion 42 that is not parallel to the first portion 40, with a corner 44 between the first and second portions 40, 42. The corner 44 may span/define an included angle 46 (FIG. 2) between at least part of the first portion 40 and at least part of the second portion 42 that is at least thirty degrees, and may be between 30 and 120 degrees. In at least some implementations, the included angle 46 of the second trim component 14 is the same as the included angle 34 of the first trim component 12 and the corner 44 of the second trim component 14 may have the same or a complementary shape as the corner 28 of the first trim component 12, at least at the outer surfaces 24, 36 thereof. In this way, the corners 28, 44 of the components 12, 14 blend together without sharp or step-wise changes in shape or dimension, at least at the interface between the trim components 12, 14 where the corner of one is immediately adjacent to the corner of the other. In this way, the first and second portions 40, 42 of the second trim component 14 may be arranged parallel to, and contiguous with, the first and second portions 30, 32 of the first trim component 12.

In the assembled state, as shown in FIGS. 1 and 4, part of the outer surface 36 of the second trim component 14, including part of both the first and second portions 40, 42, is overlapped by part of the first trim component 12. So arranged, the outer surfaces 24, 36 of the trim components 12, 14 may be aligned, in at least some implementations, such that they are flush or generally flush with each other (e.g. at the same height, where height is perpendicular to the outer surfaces), with a seam 48 (FIG. 1) between adjacent portions of the outer surfaces 24, 36 of the trim components 12, 14 and without a step-wise change in height at the seam 48/interface between the outer surfaces of the trim components 12, 14.

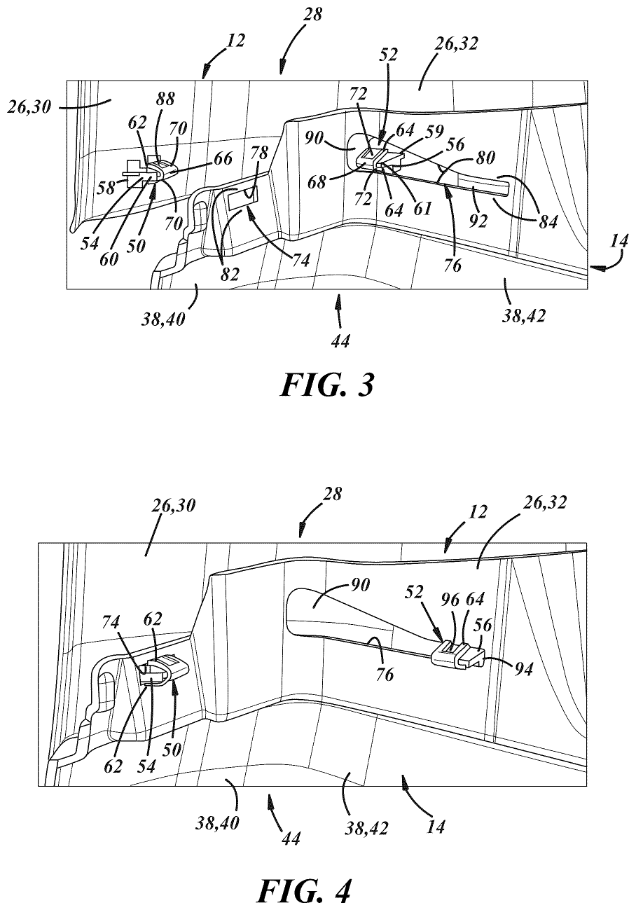

To maintain the intended, relative position of both trim components 12, 14, the trim components 12, 14 include complementary, mating connection features on both the first portions 30, 40 and second portions 32, 42. In more detail, the first trim component 12 includes a first connector 50 arranged on the inner surface 26 of the first portion 30 and a second connector 52 arranged on the inner surface 26 of the second portion 32. Each connector 50, 52 is connected to (e.g. carried by) a respective connector mount 54, 56 that extends outwardly from the inner surface 26. Referring to FIG. 3, the connector mounts 54, 56 are connected to the inner surface 26 at a first end 58, 59 and extend to a free, second end 60, 61 such that the connector mounts 54, 56 are cantilevered to the inner surface 26.

The connectors 50, 52 each include at least one connection surface (e.g. the first connector 50 has a first connection surface 62 and the second connector 52 has a second connection surface 64) that is spaced from the inner surface 26. In at least some implementations, the connection surfaces 62, 64 of each connector 50, 52 are parallel, or nearly parallel (i.e. within ten degrees of parallel) to the portion of the inner surface 26 surrounding the first ends 58, 59 of the connector mounts 54, 56. That is, the first connection surface(s) 62 defined by the first connector 50 are parallel or nearly parallel to the inner surface 26 of the first portion 30 of the first trim component 12, and the second connection surface(s) 64 defined by the second connector 52 are parallel or nearly parallel to the second portion 32 of the first trim component 12. In this way, the first connection surface(s) 62 are not parallel to the second connection surface(s) 64 and are angled at or about the magnitude of the included angle 34 between the first and second portions 30, 32 of the first trim component 12.

In the example shown, and with reference to FIG. 3, each connector 50, 52 is a V-shaped or C-shaped clip that has a first end defined by a bight 66, 68 received over the free end 60, 61 of the respective connector mount 54, 56 and arms 70, 72 that extend from the bight 66, 68 to free ends that define the connection surfaces 62, 64 and a second end of the connectors 50, 52. The free ends/connection surfaces 62, 64 are opposite the bight and on opposite sides of the connector mounts 54, 56 from each other. The end surfaces of the free ends are spaced from the inner surface 26 and individually or collectively define a or the first connection surface 62 of the first connector 50, and a or the second connection surface 64 of the second connector 52. The connectors 50, 52 are wider at the free ends 62, 64 than at the bight 66 (e.g. outer surfaces of the free ends 62, 64 are spaced farther apart than the corresponding dimension of the bight 66, and where width is a dimension parallel to the portion of the inner surface 26 to which each connector 50, 52 is connected). At least part of the arms 70, 72 of each clip 50, 52, that include the connection surface(s) 62, 64, may be movable relative to the respective connector mount 54, 56 and may be flexible and resilient. In this way, the arms 70, 72 may flex or move relative to their respective connection mount 54, 56 to facilitate assembly, as will be described in more detail later, and, in at least some implementations, to provide a biasing force or tension in the connection of the trim components 12, 14 to better hold the trim components 12, 14 in desired positions.

The connection features of the second trim component 14 may be defined by separate voids arranged to receive and interact with the connectors 50, 52 of the first trim component 12. In the example shown, the second trim component 14 includes a first connection void 74 arranged in the first portion 40, and a second connection void 76 arranged in the second connection. Each void 74, 76 extends through the thickness of the second trim component 14, that is, through the outer surface 36 and inner surface 38. So arranged, the voids 74, 76 have inner edges 78, 80 that extend between the outer surface 36 and the inner surface 38. The junction lines of the inner edges 78, 80 and the outer surface 36 are parallel to the outer surface 36.

Outboard and adjacent to the voids 74, 76, the second trim component 14 includes retention surfaces that are arranged to be overlapped by the connection surfaces 62, 64 of the connectors 50, 52 of the first trim component 12. In more detail, at least one first retention surface 82 is defined adjacent to the first connection void 74 and is overlapped in assembly by the first connection surface(s) 62 of the first connector 50, and at least one second retention surface 84 is defined adjacent to the second connection void 76 and in assembly is overlapped by the second connection surface(s) 64 of the second connector 52.

To connect the trim components 12, 14 together with the connection features (i.e. the connectors 50, 52 and connection voids 74, 76), relative movement occurs in an assembly direction denoted by arrow 86 in FIG. 2. In at least some implementations, the assembly direction is perpendicular to the first portion 30 or second portion 32 of the first trim component 12, and in the example show, it is the first portion 30. The connector mount 54 for the first connector 50 extends from the inner surface 26 generally parallel to the assembly direction.

During assembly, as shown by comparison of FIGS. 2 and 3 with FIG. 4, the first connector 50 is received in and through a length of the first connection void 74, which is the thickness of the first portion 40 of the second trim component 14, and is the dimension in the assembly direction. During insertion of the first connector 50 into the first connection void 74, the bight 66 enters the void 74 first, and the free ends 62 of the clip 50 pass through the void 74 after the bight 66. Thus, the clip 50 has a width that is less than the width between corresponding, oppositely arranged inner edges 78 of the first connection void 74. To facilitate retaining the first connector 50 within the first connection void 74, a distance between the free ends 62 of the clip 50 (e.g. a height) may be greater than a distance between corresponding inner edges 78 of the first connection void 74. So arranged, at least one arm 70 of the clip 50 must flex inwardly, to reduce the distance between the free ends 62 and enable the free ends 62 to pass through the first connection void 74. Thereafter, due to the resilience of the material of the clip 50, or under a force provided by a spring or the like, or both, the arm(s) 70 may return to or toward their unflexed position in which at least part of the first connection surface(s) 62 overlaps at least part of the first retention surface(s) 82. In at least some implementations, both free ends 62 of the clip 50 overlap separate first retention surfaces 84 of the inner surface 38 of the second trim component 14. This inhibits or prevents removal of the first connector 50 from the first connection void 74, at least without inwardly flexing of at least one of the arms 70 of the first connector/clip 50.

Further, if desired, the clip 50 may have at least a portion that is resiliently flexed (e.g. elastically deformed) in the installed position. This may occur, for example, when a distance in the assembly direction between the inner surface 26 of the first trim component 12 and the connection surface(s) is less than the thickness of the second trim component 14 adjacent the first connection void 74. This arrangement maintains the first connector/clip 50 in abutment with the first retention surface(s) 84 and tends to push the clip 50 away from the inner surface 26 of the first trim component 12 to which it is connected, and may flex a biasing member 88 of the clip. For example, the biasing member 88 may be a finger or spring member that is integrally formed with the rest of the clip, or a separate component coupled to the clip (e.g. a coil, leaf or other spring type). The clip may slide relative to the connector mount against the force of a biasing member, which then exerts a force tending to move the clip back, in the opposite direction. The biasing member 88 provides a biasing force that puts the connection between the trim components 12, 14 under some tension, to maintain the trim components 12, 14 close together and resist relative movement between the components 12, 14 (e.g. in, but not limited to, a direction opposite to the assembly direction).

As shown in FIGS. 2-4, while the first connector 50 is being assembled into the first connection void 74, the second connector 52 is assembled into the second connection void 76. Because the second connection void 76 is at an angle to the first connection void 74, sliding movement of the second connector 52 occurs relative to the second connection void 76 until the trim components 12, 14 reach the assembled position shown in FIG. 4. To accommodate this, the second connection void 76 is longer in the assembly direction than the first connection void 74, and extends from an inlet portion 90 to an end portion 92 adjacent to which the second retention surface(s) 84 are provided.

While not required, to facilitate alignment and sliding movement of the second connector 52 in the second connection void 76, the inlet portion 90 is larger than the second connector 52 in one dimension perpendicular to the assembly direction. The length of the second connection void 76 may be the dimension in the assembly direction, the height may be the dimension perpendicular to the assembly direction and to the thickness of the second portion 42 of the second trim component 14. The height of the inlet portion 90 of the second connection void 76 is greater than the height at the end portion 92 and also is greater than the height (e.g. corresponding dimension) of the second connector 52. So constructed, the arms 72 of the second connector/clip 52 need not flex inwardly in order for the second connector 52 to be received in the inlet portion 90 of the second connection void 76. This also facilitates initial alignment and insertion of the second connector 52 into the second connection void 76, which may occur outside of the viewing angle/vision of a person connecting the components as these features are in the area of overlap between the trim components 12, 14, and behind the first trim component 12 (e.g. at the inner surface 26, not the outer surface 24).

The height of the second connection void 76 decreases along its length, in any desired manner/slope/rate, to the height at the end portion 92. The height of the end portion 92 is less than the height of the second connector 52 (e.g. distance between the free ends 64). In this way, and as shown in FIG. 4, in the assembled position in which the second connector 52 is in the end portion of the second connection void 76, one or both connection surfaces 64 at the free ends of the second connector/clip 52 overlap and oppose the second retention surfaces 84 defined on opposite sides of the end portion 92 of the second connection void 76. Further, movement in the assembly direction of the second connector 52 relative to the second trim component 14 may be limited by engagement between: 1) an end surface 94 (FIG. 2) that defines part of the end portion 92 of the second connection void 76, and 2) the connector mount 56 for the second connector 52.

Further, if desired and like the first connector 50, the second connector 52 may have at least a portion that is resiliently flexed (e.g. elastically deformed) in the installed position. This may occur, for example, when a distance in the assembly direction between the inner surface 26 of the first trim component 12 and the second connection surface(s) 64 is less than the thickness of the second trim component 14 adjacent the end portion 92 of the second connection void 76. This arrangement maintains the second connector 52 in abutment with the second retention surface(s) 64 and tends to push the second connector/clip 52 away from the inner surface 38 of the second portion 32 of the first trim component 12, to which it is connected, and may flex a biasing member 96 (FIG. 4) of the clip 52. For example, the biasing member 96 may be a finger or spring member that is integrally formed with the rest of the clip, or a separate component coupled to the clip (e.g. a coil, leaf or other spring type). The clip 52 may slide relative to its connector mount 56 and cause the biasing member to exert a force, or an increased force, on the clip 52 as noted above with regard to the clip 50. The biasing member 96 provides a biasing force that puts the connection between the trim components 12, 14 under some tension, to maintain the components close together and resist relative movement between the components (e.g. in, but not limited to, a direction opposite to the assembly direction).

In at least some implementations, the biasing force of the second connector 52 is provided perpendicular to the inner surface 26 of the second portion 32 of the first trim component 12, while the biasing force of the first connector 50 is provided perpendicular to the inner surface 26 of the first portion 30 of the first trim component 12. This maintains the first portion 30 of the first trim component 12 in position relative to the first portion 40 of the second trim component 14, and the second portion 32 of the first trim component 12 in position relative to the second portion 42 of the second trim component 14. With or without the biasing forces, the trim components 12, 14 may be constructed and arranged so that, in the assembled position, the outer surfaces 24, 36 of both are maintained in a desired position, and the seam 48 between the components is consistent and even along the length of the seam 48. Further, relative movement between the trim components 12, 14 in use, can be inhibited or prevented.

The connection features of the trim components 12, 14 allow for secure retention of the trim components 12, 14, including separate connection and retention of portions of the trim components 12, 14 that are not parallel to each other. The connections between both portions of the trim components 12, 14 can occur in the same assembly direction, with a length of the first connection void 74 being equal to the thickness of the portion of the second trim component 14 in which it is formed, and the length of the second connection void 76 being greater than that. In at least some implementations, biasing forces may be provided that pull the inner surfaces 26 of both the first and second portions 30, 32 of the first trim component 12 toward and into engagement with an overlapped portion of the outer surface 36 of the first and second portions 40, 42 of the second trim component 14.

Additionally, connection of the trim components 12, 14 can be achieved with snap-fit of at least one connector in a void of the other component, and with connectors arranged at different angles overlapping surfaces of the other component that also are at the different angles. Thus, with a simple press or snap-fit in an assembly direction, portions of components at different angles can be conveniently and securely fastened together. No threaded fasteners, adhesives, bonding or other connection means are needed, in at least some implementations, although such connections could be provided in addition to the connection features described herein, if desired. Multiple connectors can be provided along the surfaces of the panels to provide a desired retention of the components relative to each other along the surface areas of the components, as desired. This can maintain a desired flushness and spacing of the components.

What is claimed is:

1. An assembly, comprising:
a first trim component having a first outer surface and a first inner surface, the first trim component also having a first connector that extends from the first inner surface and has a first connection surface that is spaced from the first inner surface, and the first trim component has a second connector that is spaced from the first connector and that extends from the first inner surface and has a second connection surface that is spaced from the first inner surface, the first connection surface is not parallel to the second connection surface; and
a second trim component that is connected to the first trim component, the second trim component has a second outer surface and a second inner surface, and the second trim component has a first connection void extending through both the second outer surface and the second inner surface with a first retention surface defined by part of the second inner surface, and the second trim component has a second connection void with a second retention surface defined by part of the second inner surface, wherein the first connector is received in the first connection void with the first connection surface abutting the first retention surface, and the second connector is received in the second connection void with the second connection surface abutting the second retention surface.

2. The assembly of claim 1 wherein the first trim component has a thickness defined between the first inner surface and the first outer surface, the first connector is received in the first connection void in an assembly direction, and the second connector is received in and movable relative to the second connection void in the assembly direction, and wherein the second connection void has a length in the assembly direction that is greater than the thickness, and the first connection void has a length in the assembly direction that is equal to the thickness.

3. The assembly of claim 2 wherein first connector has a first end that is spaced from the first connection surface and is the farthest point of the first connector from the first inner surface, and wherein the length of the second connection void is at least equal to a distance between the first end and the first retention surface.

4. The assembly of claim 1 wherein an included angle between the first retention surface and the second retention surface is between 30 degrees and 120 degrees.

5. The assembly of claim 2 wherein the second connection void includes an inlet portion and an end portion and the end portion has a dimension perpendicular to both the thickness of the second trim component and to the assembly direction that is less than the corresponding dimension of the inlet portion.

6. The assembly of claim 5 wherein the second retention surface is defined by a portion of the second inner surface that defines the end portion.

7. The assembly of claim 2 wherein the second connector is spaced from the first inner surface by a distance equal to or greater than the thickness of the second trim component in the area of the second connection void.

8. The assembly of claim 2 wherein the second connection surface overlaps the second retention surface in a direction parallel to the assembly direction.

9. The assembly of claim 8 wherein the first connection surface is parallel to the first retention surface.

10. The assembly of claim 1 wherein the first trim component includes a first connector mount on which the first connector is received, the first connector mount is cantilevered at a first end to the first inner surface and extends to a second end, and the first connector overlaps the second end of the first connector mount and at least part of the first connector is movable relative to the first connector mount to enable a snap-fit receipt of the first connector in the first connection void.

11. The assembly of claim 10 wherein the first connection surface is defined by a second end of the first connector that is opposite to a first end of the first connector that is adjacent to the second end of the first connector mount, and a distance between the second end and the first inner surface is equal to or greater than a thickness of the second trim component at the first connection void, where the thickness of the second trim component is defined between the second outer surface and the second inner surface.

12. The assembly of claim 11 wherein the second end of the first connector is flexible and has a dimension greater than a corresponding dimension of the first connection void, and to first connector is constructed so that the second end flexes so that the second end is received through the first connection void during assembly and the second end is resilient so that the second end unflexes and overlaps the first retention surface in an assembled position of the trim components.

13. The assembly of claim 1 wherein the first trim component includes a second connector mount on which the second connector is received, the second connector mount is cantilevered at a first end to the first inner surface and extends to a second end, and the second connector overlaps the second end of the second connector mount, and at least part of the second connector is movable relative to the second connector mount to provide a biasing force between the second connector and the second retention surface.

14. The assembly of claim 13 wherein the second connection surface is defined by a second end of the second connector that is opposite to a first end of the second connector, and a distance between the second end and the first inner surface is equal to or greater than a thickness of the second trim component at the second connection void, where the thickness of the second trim component is defined between the second outer surface and the second inner surface.

15. The assembly of claim 1 wherein part of the first inner surface of the first trim component overlaps part of the second outer surface of the second trim component, and wherein the first connector and the second connector each include a biasing member that is flexible and resilient and that provides a biasing force against the respective first retention surface and second retention surface that tends to pull the first inner surface toward the second outer surface.

16. The assembly of claim 15 wherein the first connector and second connector are C-shaped spring clips that are received on corresponding connectors mounts of the first trim component and that can flex or move relative to the first connector mount and second connector mount to apply the biasing force.
